(19) United States
(12) Patent Application Publication
(10) Pub. No.: US 2006/0046598 A1
(43) Pub. Date: Mar. 2, 2006

(54) Light weight fire-blocking insulation blanket with improved durability and handleability

(75) Inventor: Hemang M. Shah, Fremont, CA (US)

Correspondence Address: Brian M. Berliner;O'MELVENY & MYERS LLP, 400 South Hope Street, Los Angeles, CA, 90071-2899, US

(73) Assignee: ORCON CORPORATION

(21) Appl. No.: 11/202,290

(22) Filed: Aug. 10, 2005

Related U.S. Application Data
(60) Provisional application No. 60/604,996, filed on Aug. 27, 2004.

(51) Int. Cl. B32B 5/26; D04H 13/00; B32B 27/12; B32B 29/02

(52) U.S. Cl. 442/394; 442/327; 442/35; 442/412

(57) ABSTRACT

A lightweight insulation blanket for aircraft insulation or the like includes a lofted fibrous batting laminated to a relatively tough or high-tensile sheet of thin material, which provides improved handleability and durability to the batting. The high-tensile sheet may be a flexible fire-blocking sheet or non-woven fabric of refractory materials, which may be reinforced by a scrim. The batting and laminated fire-blocking sheet may be encased in a protective covering.

### CROSS-REFERENCE TO RELATED APPLICATION

This application claims priority pursuant to 35 U.S.C. § 119(e) to U.S. Provisional Application No. 60/604,996, filed Aug. 27, 2004, which application is specifically incorporated herein, in its entirety, by reference.

### BACKGROUND OF THE INVENTION

1. Field of the Invention

This invention relates to insulation blankets for providing thermal and acoustic insulation for mobile structures. More particularly, this invention relates to light weight insulation blankets that contain fire-blocking materials for delaying penetration of fire into a mobile structure, such as an aircraft.

2. Description of Related Art

Various light weight thermal/acoustic insulation blankets are known for providing protection from temperature extremes and noise for mobile structures, for example, for passenger cabins of airplanes. Insulation blankets for aircraft are typically placed adjacent to the interior skin of the aircraft fuselage, exterior to the interior panels of the cabin. Such insulation blankets are typically comprised of a fibrous lofted insulation such as fiberglass batting encased within a protective covering. The protective covering is typically made from primarily two pieces of lightweight, tear-resistant reinforced polymer films. The protective covering serves to prevent moisture from being absorbed by the fiberglass batting during the service life of the insulation blanket, to facilitate installation, and to protect the insulation batting from damage during installation. The protective covering may also provide a selvedge, which may be used for attachment of the insulation blankets to the frame of the aircraft or other structure.

The protective covering may be secured relative to the encased fiberglass batting using an array of ties or clips that pass through the batting material and are secured opposite exterior sides of the protective covering. In some cases, the protective covering may be secured to the batting material using an array of adhesive dots placed between the protective covering and the insulation batting. In comparison, continuous lamination of the protective covering to the insulation batting is generally believed undesirable for aircraft insulation blankets. It has been shown, for example, that continuously laminated blankets generally fail FAA flammability requirements because the laminated protective covering will propagate fire too readily.

More recently, thermal/acoustic insulation blankets have been used to delay ingress of an external fire into the passenger cabin. External fuel fires, in which aviation fuel ignites around the exterior of a crashed airplane, sometimes occur during otherwise survivable crashes. In the absence of a suitable barrier, flame and heat from burning fuel can quickly penetrate into the aircraft interior and overcome the passengers before they escape. It is believed that a greater degree of fire protection in the aircraft insulation will enable the escape or rescue of passengers that might otherwise perish. For example, the Federal Aviation Administration (FAA) recently enacted FAA Rule 25.856 paragraph B, mandating certain fire protection requirements for commercial transport aircraft.

One approach to meeting more stringent fire protection requirements is to add one or more layers of relatively thin, lightweight fire-blocking materials to an otherwise conventional insulation blanket, adjacent and coextensive with the fiberglass batting material. Such fire-blocking materials may include, for example refractory materials such as refractory aluminoborosilicate and aluminosilica fibers or other ceramic fibers, basalt fibers, leached glass fibers, or rock wool. Such materials may be provided in the form of a lofted, relatively thick material, or as a relatively thin non-lofted material, such as a non-woven paper or felt. Yet another commercially available fire-blocking material comprises an aramid/mica blended paper. Aramid/mica paper may be produced by blending about 50% mica platelets with short fibers and filmy particles of synthetic aromatic polyamide polymer, and calendaring at elevated temperature and pressure, resulting in a relatively impermeable sheet with good mechanical integrity. Aramid/mica paper may be commercially obtained in various thicknesses down to about 3 mil (0.08 mm).

FAA requirements specify that the insulation material provide a defined degree of thermal insulation during a fire, in addition to preventing penetration of flame. It has been demonstrated that the FAA requirements for thermal insulation can be provided by placing a thin layer of fire-blocking material on the exterior side of a conventional fiberglass batting. Although the fire-blocking material provides little thermal insulation, it prevents the flame from destroying the fiberglass batting, which therefore remains in place to provide the desired thermal insulation. To provide effective protection using this type of arrangement, it is therefore essential that the combination of the fiberglass and the fire-blocking layer remain uniform and intact over the area to be protected.

Although known fire-blocking materials can be combined with conventional insulation blankets to meet FAA fire protection requirements at the time of installation, too little attention has been paid to maintaining the same high level of protection over the expected service life of the blankets. Insulation blankets are removed and reinstalled in the lower lobe of the aircraft during annual maintenance, exposing them to a considerable amount of handling. For example, blankets may be bent, rolled, folded, pulled, or shoved into confined spaces during removal or re-installation. In addition, blankets are susceptible to becoming sodden with condensation or other fluids, which may penetrate the protective covering of the blanket through ventilation holes, small tears or pin holes. As a result, the fiberglass batting may become matted or torn, resulting in a loss of thermal insulation. In general, the fragility of an insulation blanket tends to increase with age, and such blankets are susceptible to damage while being handled during maintenance procedures.

Minor damage to conventional thermal/acoustic insulation blankets is not generally regarded as important. However, when the blanket is performing a fire blocking function, minor damage may permit rapid penetration of a flame, resulting in failure of the entire system. For example, a slumped or torn fiberglass batting may disrupt an adjacent layer of fire-blocking material, permitting flame penetration. It is desirable, therefore, to provide a light weight fire-blocking insulation blanket with improved durability and handleability, which will better maintain the fire-protective qualities of a fire-blocking insulation system over the service life of its component insulation blankets.

### SUMMARY OF THE INVENTION

The invention provides a light weight fire-blocking insulation blanket that overcomes the limitations of the prior art. The blanket comprises one or more layers of fiberglass batting laminated to a fire-blocking layer, wherein the fire-blocking layer provides mechanical strength and handleability to the batting material. Preferably, the fire-blocking layer comprises a relatively high-tensile-strength (i.e., tear-resistant) thin barrier material that is reinforced using a light weight scrim, prior to lamination to the batting. The scrim may be used as a carrier for a heat-activated adhesive, which may be reactivated during a hot nip lamination process to laminate the fire-blocking layer to the batting. Preferably, the laminating adhesive is moisture resistant. In addition, the fire-blocking layer should be relatively impervious to water and not likely to be weakened by the presence of moisture. Advantageously, the presence of a continuous layer of laminating adhesive on the fire-blocking layer can provide an additional permeance barrier.

The batting with its laminated fire-blocking layer and reinforcement scrim should then be encased inside a protective-covering film in a conventional matter, to provide a completed insulation blanket. Optionally, multiple layers of laminated fiberglass batting/fire-blocking layer may be stacked and encased together within the protective covering film, for greater thermal insulation and fire protection. The protective covering film may comprise a reinforced polyimide film, or other suitable impervious film material. Polyimide film may be preferable because it possesses a degree of thermal and flame resistance, which may prove helpful in retaining the insulation blanket on the airframe during a fire.

Any suitable fire-blocking material may be used in a laminated assembly according to the invention. In an embodiment of the invention, an aramid/mica sheet about 3 to 5 mils thick may be laminated to a one-inch thick batting of conventional airframe fiberglass, to provide a blanket that meets FAA fire protection requirements with only a relatively small increase in weight over a conventional non-fire-blocking blanket. Using the methods disclosed herein, very little adhesive is needed to form an effective bond, and the laminated assembly shows no significant decrease in insulation or fire-blocking performance characteristics. Fire-blocking layers with similar properties may also be suitable; for example, thin ceramic paper treated with a suitable water repellant binder or coating. Various densities and other thicknesses of fiberglass may also be suitable in the laminated assembly, instead of, or in addition to, the one-inch batting.

The invention thus provides several previously-unrecognized benefits over the prior art practice, in which the fire-blocking layer is not laminated to the fiberglass batting. For one thing, the laminated batting material is made more durable and tear-resistant by the lamination of the relatively strong fire-blocking layer. The fire-blocking layer should also help prevent slumping of the fiberglass material that is laminated to it, in the event that moisture penetrates the protective covering of the blanket. For example, if conventional ties or clips are used, the presence of the fire-blocking layer may greatly enhance their holding power, by providing a relatively high-tensile strength layer of anchor material. The fire-blocking layer and lamination adhesive may also provide an additional barrier against absorption of moisture by the batting material. A further benefit may be provided during assembly of the insulation blanket, as both the fire-blocking layer and the fiberglass batting may be rendered easier to handle by virtue of being laminated together as one piece.

These benefits provided by the laminated fire-blocking layer, which are over and above its previously-recognized fire-blocking function, may be desired in non-fire-blocking systems, as well. Accordingly, in an alternative embodiment, the fire-blocking layer may be replaced by a layer of material with similar mechanical properties, but without significant fire-blocking properties. Such a replacement material should, however, be generally flame-resistant in resisting ignition and propagation of fire. For example, various woven or non-woven fabrics treated with a suitable flame retardant may suffice, as may flame-retardant polymer films.

A more complete understanding of the light weight fire-blocking insulation blanket with improved durability and handleability will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a cross-sectional diagram showing an exemplary insulation blanket according to the invention.

FIG. 2 is a cross-sectional diagram showing an exemplary insulation blanket according to an alternative embodiment of the invention.

FIG. 3 is a cross-sectional diagram showing an exemplary insulation blanket according to another alternative embodiment of the invention.

FIG. 4 is a chart comparing tear resistance of reinforced and unreinforced mica/aramid fire-blocking materials.

FIG. 5 is a chart comparing penetration resistance of reinforced and unreinforced mica/aramid fire-blocking materials.

FIG. 6 is a chart comparing burst strength of reinforced and unreinforced mica/aramid fire-blocking materials.

### DETAILED DESCRIPTION OF THE PREFERRED EMBODIMENT

The present invention provides a light weight fire-blocking insulation blanket with improved durability and handleability. In the detailed description that follows, like element numerals are used to indicate like elements appearing in one of more of the figures.

The present invention may be adapted for use in aircraft insulation blankets and the like, for example, blankets used in insulating the cabins of passenger aircraft. The invention may be particularly useful for providing blankets to be used in an insulation system compliant with FAA requirements for thermal/acoustic insulation blankets, although the invention is not limited thereby. The general design, manufacture, and application of conventional aircraft insulation blankets is well-understood in the art, and need not be discussed here. Likewise, the principles of the invention may be adapted for use in similar insulation systems by one of ordinary skill.

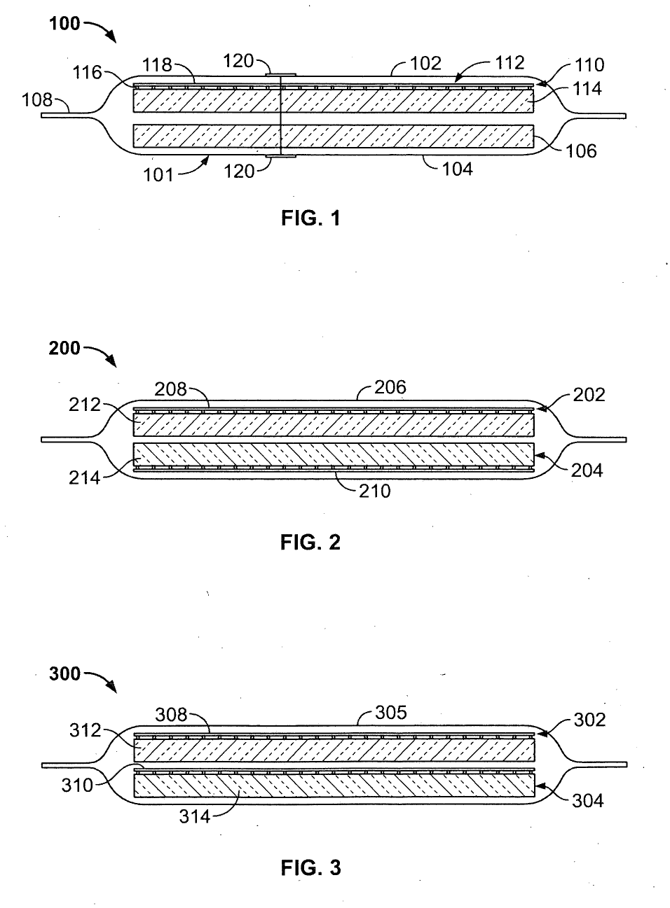

FIGS. 1-3 shows cross-sectional schematic views of exemplary insulation blankets 100, 200, 300 according to the invention. It should be apparent that the diagrams of FIGS. 1-3 are not drawn to scale nor are intended to provide a pictorial representation of any particular insulation blanket. Actual insulation blankets may differ in appearance or in particular details from the examples shown schematically in FIGS. 1-3, while still structurally conforming to one of the depicted embodiments, as should be appreciated by one of ordinary skill.

FIG. 1 shows an exemplary insulation blanket 100 comprising one or more layers of fibrous insulation batting 106, 114 encased inside a protective covering 101. At least one of the blankets 114 is a component of a reinforced assembly 110, further comprising a thin relatively high-tensile strength (i.e., tear-resistant) layer 112 laminated to batting 114. In an embodiment of the invention intended for fire-blocking applications, layer 112 comprises a layer of fire-blocking material 118, optionally reinforced by a scrim 116. Scrim 116 and fire-blocking layer 118 may be coated with a thermoplastic or heat-activated adhesive (not shown) on the side facing batting 114, for adhering layer 112 to batting 114. In an alternative embodiment not intended for fire-blocking applications, material 118 may be replaced by a layer of material that is relatively high-strength and preferably flame-resistant, but without fire-blocking properties. It may likewise be reinforced with a scrim 116 and adhered to batting 114.

Battings 106, 104 may comprise any desired thickness and density of fibrous or foam insulation material. For example, for aircraft application, battings comprising microfibrous glass in densities of 0.34, 0.42, and 0.60 pounds per cubic foot, and in thicknesses of 0.5 to 1.0 inch are, may be typical. Other batting or insulating materials may also be used. The invention is particularly useful with fibrous glass materials as used for aircraft insulation, however, because such materials tend to be somewhat fragile and prone to moisture absorption. Layer 112 may provide an additional moisture barrier for the batting, as well as providing reinforcement for strengthening and durability.

Protection covering 101 may be comprised of separate films 102, 104, joined together around the perimeter of blanket 100 by a seam 108. Seam 108 may be in the form of a selvedge, or any other suitable seam may be used. Films 102, 104 may comprise any suitable polymer film material. For aircraft applications, thin films reinforced with a lightweight scrim have proven to provide the best performance at the lightest weight. Various suitable films are known in the art and commercially available to meet manufacturer specifications and other requirements for such materials. Methods for joining such films in assembly of insulation blankets are also known. For example, reinforced polyimide films available from ORCON® Corporation of Union City, Calif., under the trade names KN-201™ or KN-202™ may be suitable for fire-blocking blankets intended for use in aircraft.

After assembling assembly 110 and batting 106 inside protective covering 101 to form insulation blanket 100, an array of ties or clips 120 (one of many shown) may be inserted though the interior contents of the blanket and secured on opposite sides of films 102, 104. Various ties or clips, and methods for securing them, are known in the art, and any suitable securing device or method may be used. Clips such as clips 120 serve to hold battings 106, 114 in place relative to protective covering 101. The presence of high-tensile layer 112 provides a more secure hold for clip 120, thereby reducing the likelihood that battings 106, 114 will fall out of place or tear during the service life of the blanket. An additional benefit is provided by the clips, in that layer 112 is also secured in place, helping to ensure a continuous layer of fire-blocking material across the blanket.

Various thin, relatively high-strength materials may be used for layer 118. For fire-blocking applications, a commercially available aramid/mica blended paper, produced by blending about 50% mica platelets with short fibers and filmy particles of synthetic aromatic polyamide polymer, and calendaring at elevated temperature and pressure. The resulting sheet is relatively impermeable, flexible, and strong sheet. Aramid/mica paper may be commercially obtained in various thicknesses down to about 3 mil (0.08 mm); thicknesses in the range of about 2 to 6 mils are believed preferable for constructing insulation blankets to meet FAA requirements. One such material is available as Dupont® NOMEX® Type 418™. In a 3 mil thickness, Type 418™ material has a tensile strength of 19-29 N/cm and an initial tear strength of 5-8 N. The material is flexible and non-brittle. Its tensile strength may be improved by laminating to a layer of reinforcement scrim. For example, a woven or non-woven oriented scrim, 10×12 threads per inch using 70 denier polyamide or polyester yarn may provide suitable lightweight reinforcement for aircraft fire-blocking applications. Other suitable scrims may include, for example, leno-weave polyester or polyamide scrims. Suitable scrims should be relatively lightweight, for example, below about 0.5 ounces per square yard, or more preferably, in the range of about 0.1 to 0.4 ounces per square yard, depending on the degree of reinforcement desired. Yarns used in such scrims may typically have denier values between about 30 to 100 denier, although smaller or larger yarns may also be suitable. Such scrims may be provided in any suitable mesh, with meshes in the range of about 6 by 6 yarns per inch (warp/fill) to 12 by 12 being considered fairly typical for aircraft applications.

Other suitable fire-blocking materials may include, for example refractory materials such as refractory aluminoborosilicate and aluminosilica fibers or other ceramic fibers, basalt fibers, leached glass fibers, or rock wool. Such materials may be provided in the form of a relatively thin non-woven paper or felt. One such material is commercially available from 3M® Corporation, under the trade name NEXTEL™. Disadvantageously, ceramic and other refractory fibers tend to be more brittle than the calendared aramid/mica material described above, although the fire-blocking properties of these materials are comparable. These materials may likewise be laminated to a reinforcement scrim for improvement of mechanical properties.

Various methods may be used to laminate the high-tensile-strength layer 112 to batting 114. One approach involves pre-coating one side of layer 112 with a substantially or completely continuous film of heat-activated adhesive. The adhesive may be selected to be reactivated after its initial cure, by application of heat. It may also be selected to provide an additional degree of resistance to water permeance. The adhesive can be applied during lamination of scrim 116 (if present), or in a separate step. For example, any suitable scrim may be laminated to a fire-blocking material such as aramid/mica using an aqueous polyvinyl chloride emulsion, formulated for thermoplastic properties after initial cure, or any other suitable adhesive. In the alternative, or in addition, a suitable adhesive may be provided during lamination to a batting material, for example, by application of a hot melt film adhesive, web adhesive, powder adhesive, or other adhesives between the batting and the high-strength layer. Suitable laminating adhesives are well known in the art. The layer 112 with a cured layer of heat-activated adhesive and optionally scrim can be produced as a production intermediate, and if desired stored for lamination to a suitable insulation batting at a later time.

Layer 112 with a pre-applied heat-activated adhesive coating may be laminated to a suitable batting using a hot-nip lamination process, wherein a batting 114 and reinforcement layer 112 are lain together and passed under a heated roller, which heats layer 112 and presses it to the batting while the adhesive is activated. Advantageously, lamination can be achieved with little or no need to control volatile emissions. In the alternative, any other suitable lamination process may be used; including, for example, wet lamination. After lamination, batting assembly 110 may be cut to shape and assembled in protective covering 101.

Various other configurations of insulation blanket may be used to improve on the reliability and effectiveness of the fire protection provided by the blanket, without substantially increasing weight or cost. FIG. 2 shows an insulation blanket 200 comprising two laminated fire-blocking batting assemblies 202, 204 placed back-to-back inside a protective covering 206. Each assembly 202, 204 comprises a fire-blocking material layer 208, 210 as previously described, laminated to a batting 212, 214. Other details of blanket 200 may be as previously described for blanket 100. Advantageously, insulation blanket 200 provides the same level of fire-blocking protection, regardless of which side is oriented towards the aircraft skin. Thus, an error in installation of the blanket will not cause any decrease in the level of protection afforded by the insulation system.

A third alternative configuration is illustrated by blanket 300, shown in FIG. 3. Blanket 300 is designed to improve the level of thermal insulation provided by the insulation system, while providing a level of redundancy for both fire-blocking and thermal insulation layers. Blanket 300 comprises laminated fire-blocking batting assemblies 302, 304 arranged in parallel configuration inside of a protective covering. Other details of blanket 300 may be as previously described for blankets 100, 200. Each assembly 302, 304 is oriented with its fire-blocking layer facing towards the outboard side 305 of blanket 300, which is designed to face towards the exterior of the aircraft. In case of failure of a first fire-blocking layer 308, its laminated batting 312 will quickly be consumed by fire. However, second fire-blocking layer 310 will provide a secondary level of protection from flame penetration, while protecting a second layer of thermal insulation 314 from being consumed by fire.

Generally comparing blankets 200, 300 to blanket 100, approximately the same level of fire-blocking protection may be provided using approximately the same mass per unit area of fire-blocking material, all other things being equal. Thus, for example, layers 208, 210 in blanket 200 may each have about half the mass per unit area as layer 112 in blanket 100, if approximately the same level of fire-blocking protection is desired.

It should also be apparent that in the alternative to, or in addition to, laminating a fire-blocking layer to a batting of thermal insulation material, a similar fire-blocking layer may be laminated to an interior side of the protective covering, and then attached to the insulation batting using clips as described herein. However, lamination directly to the batting is believed preferable, despite being contrary to conventional practice for aircraft insulation, and despite the greater care required to achieve an acceptable bond to a fibrous batting material without a weight penalty due to increased use of adhesive. Advantages of the batting/fire-blocking laminate include, for example, a greater ease of assembly of the insulation blanket using conventional assembly methods, and improved durability and service life of the insulation batting.

Further details concerning the invention may be apparent from the following examples:

### EXAMPLE 1

A non-woven oriented 10×12 thread per inch scrim of 70 denier polyamide fiber was applied to one side of a 5 mil aramid/mica Nomex® Type 418™ paper using a water-based polyvinyl chloride adhesive applied to the fill yarns only of the scrim. The fill yarns at 12 per inch were wrapped over and around the warp yarns at 10 per inch and the mica-aramid paper, which was wrapped around on a cylindrical tube. The adhesive was cured in a cylindrical convection oven, then the aramid/mica was slit to release it from the cylinder, lain flat, and collected on a finish roll. The finish roll and a roll of 0.43 pounds/cubic foot (pcf) one inch thick MICROLIGHT™ AA fiberglass batting from Johns Manville Corporation were loaded on a hot roll laminator and laminated together using a hot roller at 375° F. and a nip pressure of 80 psi. The resulting fiberglass batting laminate was cut to length and assembled into a finished aircraft insulation blanket configured according to FIG. 1, using ORCON® KN-201™ polyimide reinforced film for the protective covering. This blanket replicated an earlier blanket that had been tested and found compliant with FAA Rule 25.856 paragraph B, except the earlier blanket incorporated a hand-laminated batting using 0.34 pcf fiberglass.

### EXAMPLE 2

A length of non-woven ceramic 3 mil fiber paper, supplied by 3M under the trade name Nextel® 312, was reinforced as described in example 1. The resulting reinforced ceramic paper was laminated to a length of one inch thick, 0.34 pcf MICROLIGHT™ AA fiberglass batting. The resulting laminate was assembled into an insulation blanket configured according to FIG. 1, using ORCON® KN-201™ polyimide reinforced film for the protective covering. This blanket was tested and found compliant with FAA Rule 25.856 paragraph B.

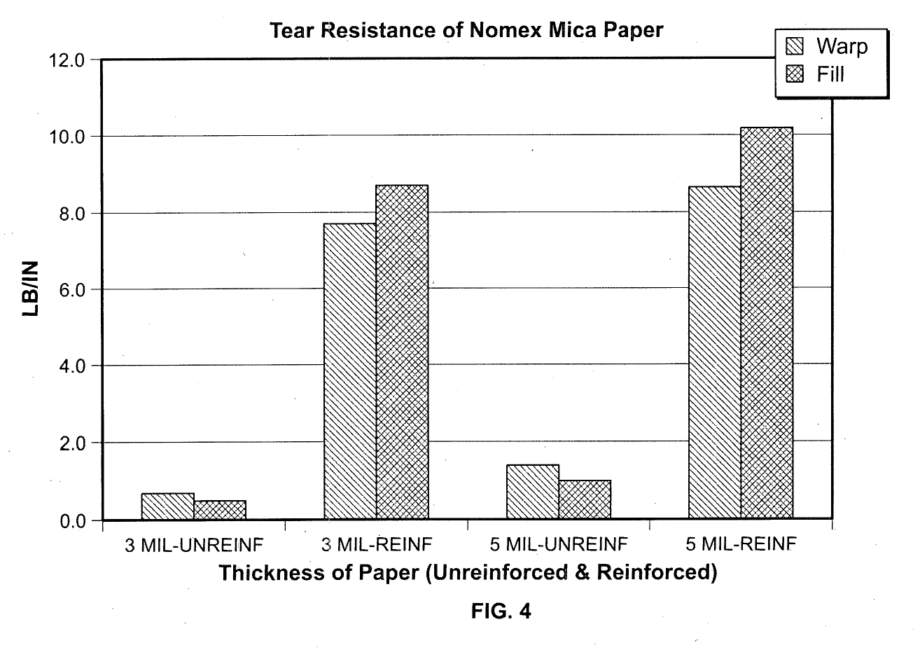

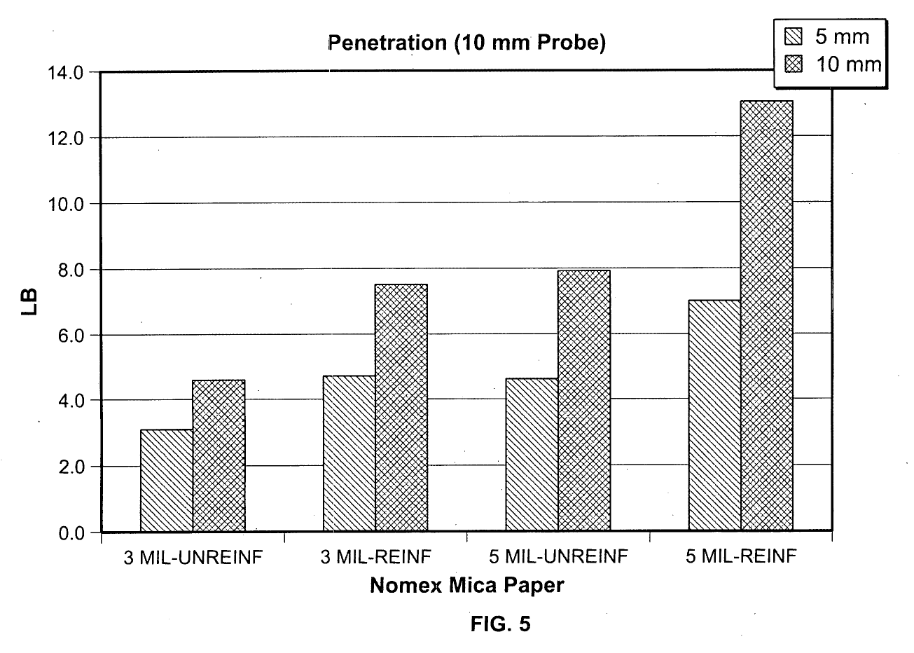

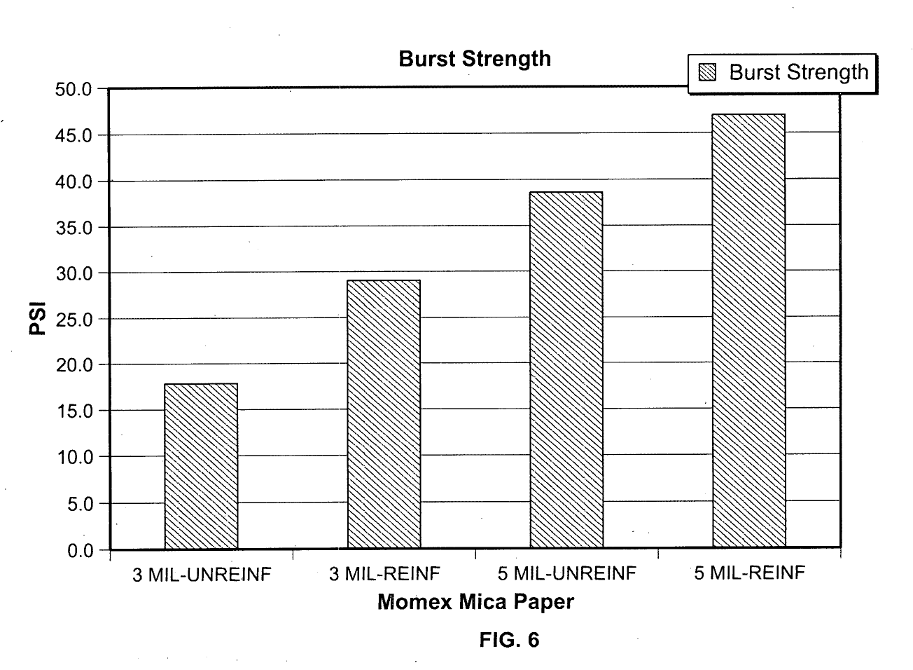

Lamination of a reinforcement scrim to the high-strength layer may provide a substantial increase in the tear resistance, penetration resistance, puncture resistance, and other mechanical properties of the high strength layer. For example, lamination of a scrim as described in Example 1 to aramid/mica Nomex® Type 418™ paper, 3 mil or 5 mil thick, respectively, increased the tear strength of the high-strength layer by a factor of about ten, as shown in FIG. 4. Likewise, substantial increases were also observed in penetration resistance and burst resistance, as shown in FIGS. 5 and 6, respectively. These properties are believed to provide improved durability and handleability for a finished insulation blanket. For example, a blanket incorporating a laminated aramid/mica sheet according to the invention was tested to assess its durability during multiple cycles of assembly and removal from an air frame. The insulation blanket was not damaged and its laminated lofted insulation material was maintained in essentially original condition during the test.

Having thus described a preferred embodiment of light weight fire-blocking insulation blanket with improved durability and handleability, it should be apparent to those skilled in the art that certain advantages of the within system have been achieved. It should also be appreciated that various modifications, adaptations, and alternative embodiments thereof may be made within the scope and spirit of the present invention. For example, embodiments using aramid/mica paper as fire blocking material have been illustrated, but it should be apparent that the inventive concepts described above would be equally applicable to use of comparable fire-blocking materials. The invention is defined by the following claims.

What is claimed is:

1. An insulation blanket, comprising:
at least one layer of lofted fibrous insulation batting;
a protective covering encasing the batting, the protective covering comprising a polymer film; and
a tear-resistant sheet of non-lofted fire-blocking material laminated to and covering a side of the batting.

2. The insulation blanket of claim 1, wherein the fire-blocking material further comprises a laminated scrim.

3. The insulation blanket of claim 1, wherein the fire-blocking material further comprises a fire-blocking material coupled to a scrim reinforcement.

4. The insulation blanket of claim 1, wherein the fire-blocking material further comprises a moisture barrier.

5. The insulation blanket of claim 1, wherein the fire-blocking material further comprises a polymer film.

6. The insulation blanket of claim 1, wherein the fire-blocking material further comprises an aramid/mica blended paper.

7. The insulation blanket of claim 6, wherein the aramid/mica blended paper comprises a calendared sheet of about 50% mica platelets blended with particles of aromatic polyamide polymer.

8. The insulation blanket of claim 6, wherein the aramid/mica blended paper further comprises a laminated scrim.

9. The insulation blanket of claim 8, wherein the laminated scrim comprises a yarn material selected from the group consisting of polyamide, polyester, aramid, fiberglass, polypropylene, and cotton.

10. The insulation blanket of claim 1, wherein the fire-blocking material further comprises a non-woven material substantially thinner than the batting and comprising a fibrous refractory material selected from the group consisting of: ceramic, aluminoborosilicate, aluminosilicate, basalt, leached glass, and rock wool.

11. The insulation blanket of claim 10, wherein the aramid/mica blended paper further comprises a laminated scrim.

12. The insulation blanket of claim 1, further comprising a substantially continuous film of heat-activated adhesive interposed between the batting and the high-tensile layer.

13. The insulation blanket of claim 1, further comprising a substantially continuous scrim coated by a heat-activated adhesive interposed between the batting and the high-tensile layer.

14. The insulation blanket of claim 1, wherein the protective covering comprises a polymer film material.

15. The insulation blanket of claim 1, wherein the protective covering comprises opposing sheets of polymer film material joined together around a perimeter of the insulation blanket.

16. The insulation blanket of claim 1, wherein the batting comprises microfibrous glass and has a density in the range of 0.3 to 1.5 pounds per cubic foot.

17. The insulation blanket of claim 3, wherein the batting and fire-blocking material are arranged such that the fire-blocking material is outboard of the batting.

18. The insulation blanket of claim 3, further comprising at least a second batting laminated to a second thin layer of fire-blocking material, the second batting arranged substantially parallel to the batting with the second fire-blocking material arranged outboard of the second batting.

19. The insulation blanket of claim 1, wherein the fire-blocking material comprises a sheet material having a thickness not greater than about 200 mils.

20. The insulation blanket of claim 1, wherein the fire-blocking material comprises a sheet material having a thickness not greater than about 10 mils.

21. The insulation blanket of claim 20, wherein the fire-blocking material further comprises a sheet material having a tear resistance not less than two pounds per inch.

22. The insulation blanket of claim 20, wherein the fire-blocking material further comprises a sheet material having a tear resistance not less than 0.5 pounds per inch.

23. The insulation blanket of claim 1, wherein the protective covering is essentially free of a laminated attachment to either of the batting and the fire-blocking material.

24. The insulation blanket of claim 1, wherein the protective covering is attached to the batting using an array of clips.
